(19) United States
(12) Patent Application Publication
(10) Pub. No.: US 2007/0086315 A1
(43) Pub. Date: Apr. 19, 2007

(54) Optical disc apparatuses

(75) Inventors: Chao-Ming Huang, Hsintien City (TW); Yuh Cheng, Chubei City (TW); Gwo-Huei Wu, Banchiau City (TW); Pi-hai Liu, Taipei City (TW); Chih-Yuan Chen, Chunghua Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/254,026

(22) Filed: Oct. 19, 2005

(51) Int. Cl. G11B 7/00

(52) U.S. Cl. 369/124.11; 369/53.31

(57) ABSTRACT

Optical disc apparatuses. The apparatus comprises an optical pickup and a data recovery unit. The optical pickup irradiates laser light onto a disc, receives light reflected from the disc, and generates an RF signal in response to the received light. The data recovery unit comprises a first configuration and a second configuration. The data recovery unit receives the RF signal from the optical pickup, reproduces data according to the RF signal in the first configuration, and performs a signal quality index measurement of the RF signal in the second configuration.

### BACKGROUND

The present disclosure relates generally to optical disc apparatuses, and more particularly, to optical disc apparatuses with adjustments on a data recovery unit reproducing data from a disc.

Optical disk apparatuses for driving an optical disk, such as CDs (Compact Disc), CD-Rs (Compact Disc-Recordable), CD-RWs (Compact Disc-Rewritable) and DVDs (Digital Versatile Disc), are well known. An optical disk apparatus reproduces data recorded on a disc by irradiating laser light onto the disc from an LD (Laser Diode) and converting the light reflected from the optical disc surface into an-electric signal (RF signal).

To ensure the signal quality of RF, servo adjustments, such as tilt adjustments, spherical aberration adjustment, and offset adjustments of a focusing and/or tracking servo are performed to optimize the error rate of reproduced data. It is understood that if the error rate is minimal, the servo status is optimal. For example, if the radial tilt of an optical pickup is serious, the error rate increases. During servo adjustment, the servo status is adjusted, and a signal quality index (SQI) is read and compared with that of different servo statuses to ensure the current servo status is optimal. The signal quality index comprises error rate, jitter, PRSNR (Partial Response Signal-to-Noise Ratio), RF amplitude, and loop gain. If the signal quality index is the error rate, or jitter, the servo status is optimal when the signal quality index is minimal. If the signal quality index is the PRSNR, RF amplitude or loop gain, the servo status is optimal when the signal quality index is maximal.

As described, the sensitivity of servo adjustments is based on that of the signal quality index. The best signal quality index is error rate. The calculation for error rate, however, is time-consuming. Therefore, optical disc apparatuses always use the jitter or PRSNR as the signal quality index, in which the jitter is one of a phase type index, and the PRSNR is one of a level type index. However, another problem is the relationship between the signal quality index, such as jitter or PRSNR, and the servo status is not sensitive around the best servo status. FIG. 1 shows the relationship between the amount of signal quality index, such as jitter or PRSNR, and the servo status. As shown in FIG. 1, the amount of jitter and PRSNR for the best servo status B and that for the range I around the best servo status B are nearly the same. That is, the jitter and PRSNR cannot be used to accurately recognize the best servo status.

### SUMMARY

Optical disc apparatuses are provided. An exemplary embodiment of an optical disc apparatus comprises an optical pickup and a data recovery unit. The optical pickup irradiates laser light onto a disc, receives light reflected from the disc, and generates an RF signal in response to the received light. The data recovery unit comprises a first configuration and a second configuration. The data recovery unit receives the RF signal from the optical pickup, reproduces data according to the RF signal in the first configuration, and performs a signal quality index measurement of the RF signal in the second configuration.

### DESCRIPTION OF THE DRAWINGS

Optical disc apparatuses will become more fully understood by referring to the following detailed description with reference to the accompanying drawings, wherein:

FIG. 1 shows the relationship between jitter amount, PRSNR amount and servo status;

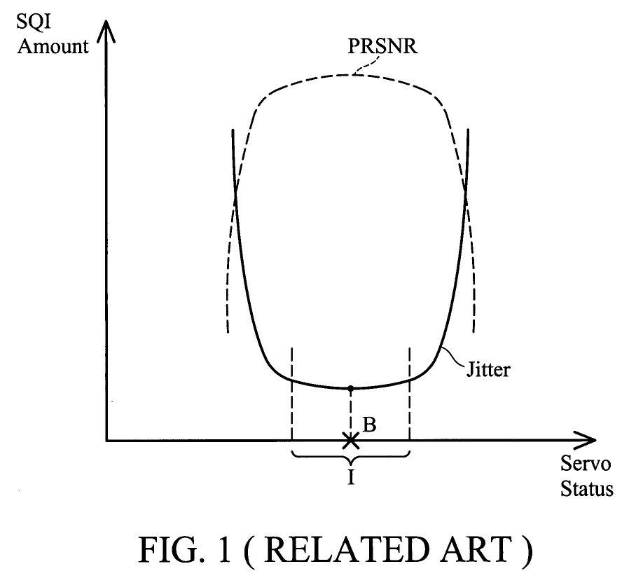

FIG. 2 is a schematic diagram illustrating an embodiment of an optical disc apparatus;

FIG. 3 is a schematic diagram illustrating an embodiment of a data recovery unit;

FIG. 4 is a schematic diagram illustrating an embodiment of a data recovery unit;

FIG. 5 is a schematic diagram illustrating an embodiment of a data recovery unit;

FIG. 6 is a schematic diagram illustrating an embodiment of a data recovery unit; and

FIG. 7 shows an embodiment of the relationship between jitter amount, PRSNR amount and servo status.

### DESCRIPTION

Optical Disc Apparatuses are Provided.

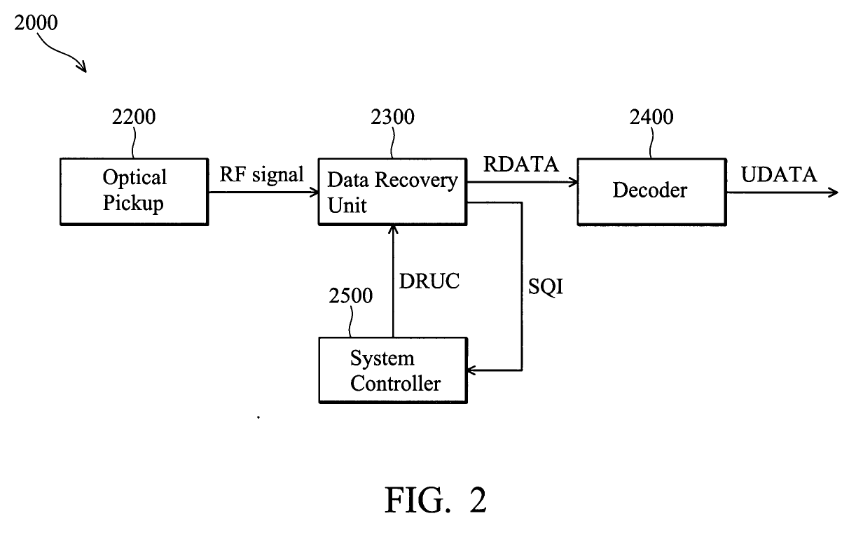

FIG. 2 is a schematic diagram illustrating an embodiment of an optical disc apparatus. The optical disc apparatus 2000 comprises an optical pickup 2200, a data recovery unit 2300, a decoder 2400, and a system controller 2500.

The optical pickup 2200 comprises a laser diode (not shown) to irradiate a laser beam onto a disc, such as a CD, a CD-R, a CD-RW, a DVD, and others. The optical pickup 2200 further comprises a photo detector (not shown) to receive the laser beam reflected from the disc, convert the reflected light into an RF signal, and output the RF signal. The optical pickup 2200 further comprises a servo structure (not shown), such as a focusing servo, tracking servo, spherical aberration adjustment servo, and a tilt adjustment servo to control the servo status, such as the radial tilt of the optical pickup 2200. It is understood that a RF amplifier (not shown) amplifies a RF signal from the optical pickup 2200 and provides the amplified signal to the data recovery unit 2300.

The data recovery unit 2300 reproduces data according to the RF signal to generate raw data (RDATA), and generates a signal quality index (SQI), such as a phase based index and a level based index accordingly. The phase based index comprises a jitter. The level based index comprises a PRSNR. Detail of the data recovery-unit 2300 is discussed later. The decoder 2400 decodes the raw data to generate user data. The system controller 2500 receives the signal quality index from the data recovery unit 2300 and performs an adjustment on the data recovery unit 2300 via a data recovery unit control signal (DRUC). Two configurations are in the data recovery unit 2300, normal data recovery operation for data reproduction, and signal quality index measurement of the RF signal for optimal servo adjustment. During the normal data recovery operation for data reproduction, the data recovery unit 2300 is well configured so that some degradation of RF quality could be compensated to achieve lower error rate of user data. However, the signal quality index may be insensitive to the change of servo status at this moment. Accordingly, during the optimal servo adjustment, such as the radial tilt adjustment of the optical pickup 2200, the data recovery unit should be switched from the normal data recovery mode to signal quality index measurement mode. The system controller 2500 adjusts the configuration of the data recovery unit 2300 to improve the sensitivity of signal quality index with respect to the change of servo status.

Various embodiments of the data recovery units are provided.

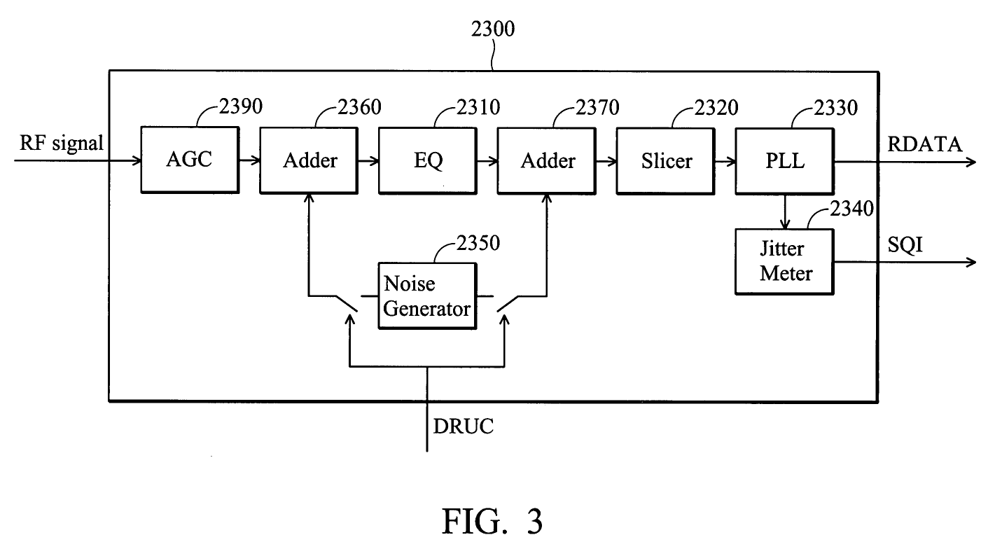

FIG. 3 is a schematic diagram illustrating an embodiment of a data recovery unit.

The data recovery unit 2300 comprises an equalizer 2310, a digitizing unit, such as a slicer 2320, a PLL (Phase-Lock Loop) circuit 2330, an AGC (Automatic Gain Controller) 2390, a SQI detector, such as a jitter meter 2340, a noise generator 2350, and adders 2360 and 2370. The AGC 2390 receives the RF signal, and performs an automatic gain adjustment on the RF signal to keep the amplitude of the RF signal the same during the normal data recovery operation. The equalizer 2310 comprises a LPF (Low-Pass Filter) (not shown) to cut off a high frequency component beyond a cut-off frequency range as noise. The equalizer 2310 further comprises a booster (not shown) to boost a high frequency region of the RF signal from the LPF. The noise generator 2350 generates a noise, and adds the noise to the RF signal prior to or/and after the equalizer 2310 by way of the adders 2360 and 2370 respectively. The slicer 2320 digitizes the RF signal output from the EQ 2310 into a sequence of binary symbols, and provides the digitized signal to the PLL circuit 2330. The digitized signal is provided to the decoder 2400 as raw data. The PLL circuit 2330 generates a clock signal having a phase synchronized with the digitized signal, and provides the clock signal to the jitter meter 2340. The jitter meter 2340 detects the phase difference, such as a jitter amount between the digitized signal and-the clock signal, and outputs the signal quality index to the system controller 2500.

During the normal data recovery operation, the noise generator 2350 is disabled and the AGC 2390 keeps on updating to maintain the amplitude of RF signal. The degradation of RF signal caused by the change of servo status may be partially compensated by the AGC 2390 and the EQ 2310. Accordingly, the SQI detector, such as the jitter meter 2340, becomes insensitive to change of the servo status at this moment.

To improve the sensitivity of the SQI detector during servo status adjustment, such as the jitter meter 2340, the system controller 2500 sends a data recovery unit control (DRUC) signal to change the configuration of the DRU 2300 from the normal data recovery operation mode to the signal quality index measurement mode. If the DRU 2300 operates in the signal quality index measurement mode, the automatic update of AGC 2390 is stopped firstly. Then, the gain of AGC 2390 can be held to the last value during the normal data recovery operation or assigned to a predetermined value. Because the automatic update of AGC 2390 is disabled, the degradation of RF signal quality can be measured by using the SQI detector, such as the jitter meter 2340.

Secondly, the noise generator 2350 is enabled and the RF signal before or after the EQ 2310 is coupled with noise. Because the noise is coupled to the RF signal, the compensation ability of the AGC 2390 and the EQ 2310 is dropped. The degradation of RF signal quality can be measured by using the SQI detector, such as the jitter meter 2340. The sensitivity of signal quality index with respect to the change of servo status, such as jitter, is improved.

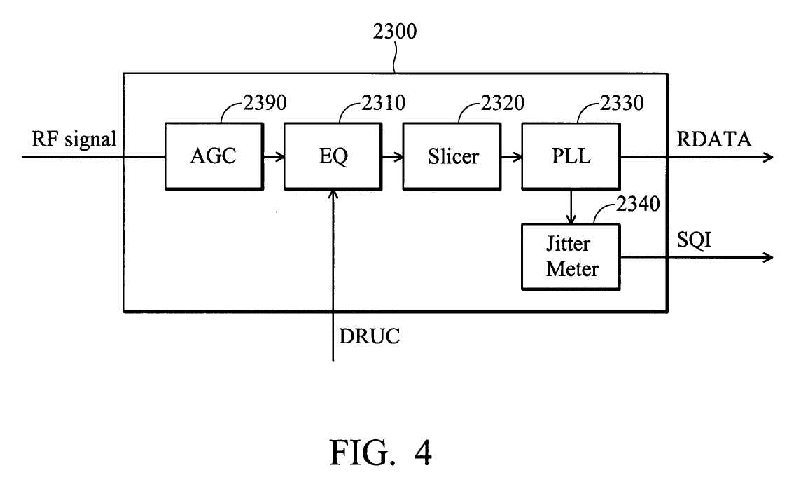

FIG. 4 is a schematic diagram illustrating an embodiment of a data recovery unit.

The data recovery unit 2300 comprises an equalizer 2310, a digitizing unit, such as a slicer 2320, a PLL circuit 2330, an AGC (Automatic Gain Controller) 2390, and a SQI detector, such as a jitter meter 2340. The AGC 2390 receives the RF signal, and performs an automatic gain adjustment on the RF signal to keep the amplitude of the RF signal the same during the normal data recovery operation. The equalizer 2310 comprises a LPF (not shown) to cut off a high frequency component beyond a cut-off frequency range as noise. The equalizer 2310 further comprises a booster (not shown) to boost a high frequency region of the RF signal from the LPF. The slicer 2320 digitizes the RF signal output from the EQ 2310 into a sequence of binary symbols, and provides the digitized signal to the PLL circuit 2330. The digitized signal is provided to the decoder 2400 as raw data. The PLL circuit 2330 generates a clock signal having a phase synchronized with the digitized signal, and provides the clock signal to the jitter meter 2340. The jitter meter 2340 detects the phase difference, such as a jitter amount between the digitized signal and the clock signal, and outputs the signal quality index to the system controller 2500.

During the normal data recovery operation, the AGC 2390 keeps on updating to maintain the amplitude of RF signal and the boost quantity of EQ 2310 is well configured for data recovery. Accordingly, the degradation of RF signal caused by the change of servo status may be partially compensated by the AGC 2390 and the EQ 2310. Accordingly, the SQI detector, such as the jitter meter 2340, becomes insensitive to change of the servo status at this moment.

To improve the sensitivity of the SQI detector during servo status adjustment, such as the jitter meter 2340, the system controller 2500 sends a data recovery unit control (DRUC) signal to change the configuration of the DRU 2300 from the normal data recovery operation mode to the signal quality index measurement mode. If the DRU 2300 operates in the signal quality index measurement mode, the automatic update of AGC 2390 is stopped firstly. Then, the gain of AGC 2390 can be held to the last value during the normal data recovery operation or assigned to a predetermined value. Because the automatic update of AGC 2390 is disabled, the degradation of RF signal quality can be measured by using the SQI detector, such as the jitter meter 2340.

Secondly, the boost quantity of EQ 2310 is changed to a pre-determined value less or more than the nominal value for data recovery operation. At this moment, the compensation ability of the EQ 2310 to the RF signal quality is dropped, and the degradation of RF signal quality can be measured by using the SQI detector, such as the jitter meter 2340. The sensitivity of signal quality index with respect to the change of servo status, such as jitter, is improved.

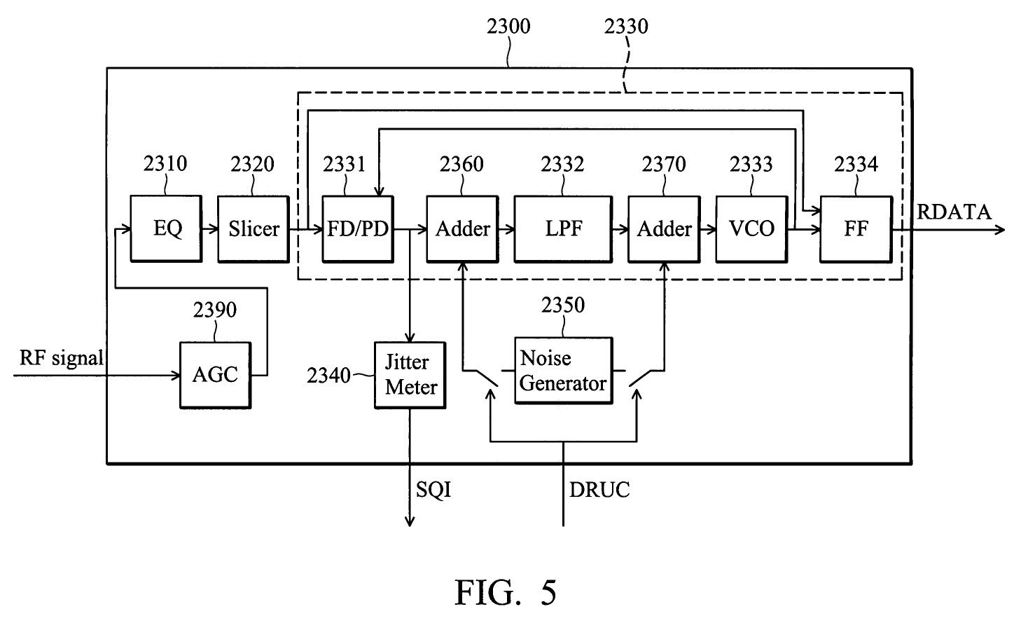

FIG. 5 is a schematic diagram illustrating an embodiment of a data recovery unit.

The data recovery unit 2300 comprises an equalizer 2310, a digitizing unit, such as a slicer 2320, a PLL circuit 2330, an AGC (Automatic Gain Controller) 2390, a SQI detector, such as a jitter meter 2340, a noise generator 2350, and adders 2360 and 2370. The AGC 2390 receives the RF signal, and performs an automatic gain adjustment on the RF signal to keep the amplitude of the RF signal the same during the normal data recovery operation. The equalizer 2310 comprises a LPF (not shown) to cut off a high frequency component beyond a cut-off frequency range as noise. The equalizer 2310 further comprises a booster (not shown) to boost a high frequency region of the RF signal from the LPF. The slicer 2320 digitizes the RF signal output from the EQ 2310 into a sequence of binary symbols, and provides the digitized signal to the PLL circuit 2330. The digitized signal is provided to the decoder 2400 as raw data.

The PLL circuit 2330 generates a clock signal having a phase synchronized with the digitized signal, and provides the clock signal to the jitter meter 2340. The PLL circuit 2330 is a conventional PLL comprising a FD (Frequency Detector)/PD (Phase Detector) 2331, a LPF (Loop Filter) 2332, a VCO (Voltage Controlled Oscillator) 2333, and a FF (Flip Flop) 2334, but with the additional adders 2360 and 2370. The detail of the PLL, circuit 2330 is well-known, and description thereof is omitted here. It is understood that the adders 2360 and 2370 can-be also removed from the PLL circuit 2330, but in the data recovery unit 2300. The noise generator 2350 generates a noise, and adds the noise to the PLL circuit 2330 in response to the adjustment request, DRUC, from the system controller 2500. The noise generated by the noise generator 2350 can be added prior to or/and after the LPF 2332 by way of the adders 2360 and 2370 respectively. The jitter meter 2340 detects the phase difference, such as a jitter amount between the digitized signal and the clock signal, and outputs the signal quality index to the system controller 2500.

During the normal data recovery operation, the noise generator 2350 is disabled, the AGC 2390 keeps on updating to maintain the amplitude of RF signal and the boost quantity of EQ 2310 is well configured for data recovery. Accordingly, the degradation of RF signal caused by the change of servo status may be partially compensated by the AGC 2390 and the EQ 2310. Accordingly, the SQI detector, such as the jitter meter 2340, becomes insensitive to change of the servo status at this moment.

To improve the sensitivity of the SQI detector during servo status adjustment, such as the jitter meter 2340, the system controller 2500 sends a data recovery unit control (DRUC) signal to change the configuration of the DRU 2300 from the normal data recovery operation mode to the signal quality index measurement mode. If the DRU 2300 operates in the signal quality index measurement mode, the automatic update of AGC 2390 is stopped firstly. Then, the gain of AGC 2390 can be held to the last value during the normal data recovery operation or assigned to a predetermined value. Because the automatic update of AGC 2390 is disabled, the degradation of RF signal quality can be measured by using the SQI detector, such as the jitter meter 2340.

Secondly, the noise generator 2350 is enabled and the PLL circuit 2330 is coupled with noise. Because the noise is coupled to the PLL circuit 2330, the degradation of RF signal quality can be measured by using the SQI detector, such as the jitter meter 2340.

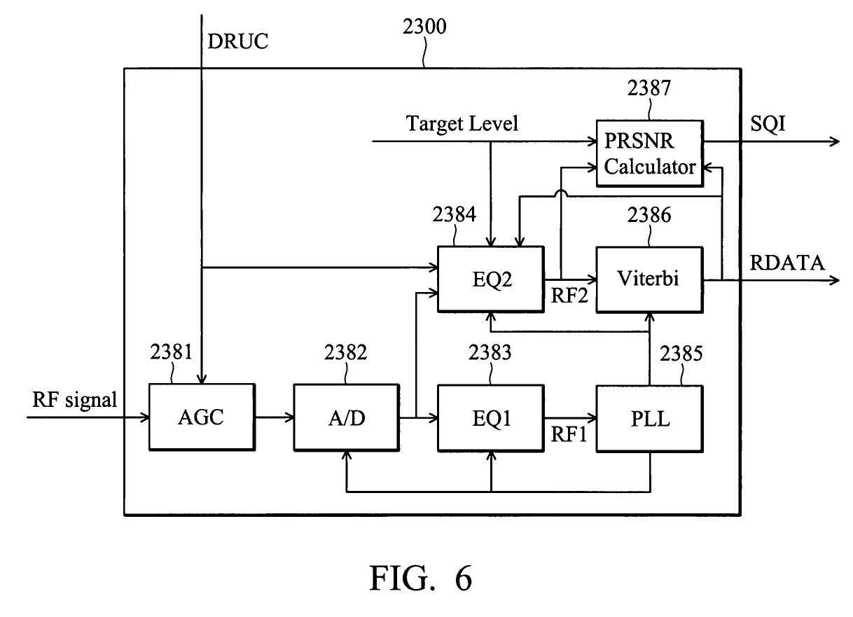

FIG. 6 is a schematic diagram illustrating an embodiment of a data recovery unit.

The data recovery unit 2300 comprises an AGC (Automatic Gain Controller) 2381, an A/D (Analog/Digital converter) 2382, a first equalizer (EQ1) 2383, a second equalizer (EQ2) 2384, a PLL circuit 2385, a Viterbi decoder 2386, and a SQI detector, such as a PRSNR calculator 2387. The AGC 2381 receives the RF signal, and performs an automatic gain adjustment on the RF signal to maintain the amplitude of the RF signal within the operation range of A/D 2382. The A/D 2382 converts the RF signal from analog to digital with the sample clock generated by the PLL circuit 2385. The output of A/D 2382 is supplied to EQ1 2383 for PLL and EQ2 2384 for Viterbi decoding. The EQ1 2383 comprises a LPF (not shown) to cut off a high frequency component beyond a cut-off frequency range as noise. The EQ1 2383 further comprises a booster (not shown) to boost a high frequency region of the RF signal from the LPF. The output of EQ1 2383, RF1, is supplied to PLL circuit 2385, then the PLL circuit 2385 generates a clock signal having a phase synchronized with the signal, and provides the clock signal to the EQ1 2383, the EQ2 2384, the A/D 2382 and the Viterbi decoder 2386. The EQ2 2384 is an adaptive digital equalizer with sample clock generated by the PLL circuit 2385. The input of the EQ2 2384 includes the target level, RDATA (raw data) output from Viterbi decoder 2386, and the RF signal output from the A/D 2382. By using the target level and RDATA output from the Viterbi decoder 2386, the EQ2 2384 generates an reference RF internally. Then by comparing the internal reference RF and the real RF signal output from the A/D 2382, the EQ2 2384 adapts its coefficients to minimize the difference between the internal reference RF and the output of the EQ2 2384, RF2.

The Viterbi decoder 2386 receives the RF signal, RF2, from the EQ2 2384 and performs a data recovery with the sample clock generated by the PLL circuit 2385. The output of Viterbi decoder 2386, RDATA (raw data), will be feedback to the EQ2 2384 and the PRSNR calculator 2387. The detail of Viterbi decoding is well-known, and description thereof is omitted here. The PRSNR calculator 2387 calculates the PRSNR of the RF signal according to the RF signal (RF2) from the EQ2 2384 and the decoding result (RDATA) from the Viterbi decoder 2386, and outputs the signal quality index to the system controller 2500. The input of the PRSNR calculator 2387 includes the RDATA output from the Viterbi decoder 2386, the RF signal, RF2, output from the EQ2 2384, and the target level. By using the RDATA output form the Viterbi decoder 2386 and the target level, the PRSNR calculator 2387 can generate a reference RF signal internally. By comparing the internal reference RF signal and the equalized RF signal, RF2, output from the EQ2 2384, the PRSNR regarded as a signal quality index can be calculated.

During the normal data recovery operation, the AGC 2381 keeps on controlling the amplitude of the RF signal into the A/D 2382 automatically, and the EQ2 2384 also keeps on updating its coefficients to make the RF signal, RF2, output from the EQ2 2384 to fit the internal reference RF signal. Because of operation of the AGC 2381 and the EQ2 2384, the degradation of the RF signal quality caused by the change of servo status may be compensated. Accordingly, the SQI detector, such as the PRSNR calculator 2387, becomes insensitive to change of the servo status at this moment.

To improve the sensitivity of the SQI detector during servo status adjustment, such as the PRSNR calculator 2387, the system controller 2500 sends a data recovery unit control (DRUC) signal to change the configuration of the DRU 2300 from the normal data recovery operation mode to the signal quality index measurement mode. First, the automatic update of AGC 2381 is stopped. Then, the gain of AGC 2381 can be held to the last value during the normal data recovery operation or assigned to a predetermined value. Because the automatic update of AGC 2381 is disabled, the degradation of RF signal quality can be measured by using the SQI detector, such as the PRSNR calculator 2387.

Secondly, the automatic update of EQ2 2384 is also stopped. Then, the coefficients of EQ2 2384 can be held to the last value during the normal data recovery operation or assigned to predetermined values. Because the automatic update of EQ2 2384 is disabled, the degradation of RF signal quality can be measured by using the SQI detector, such as the PRSNR calculator 2387.

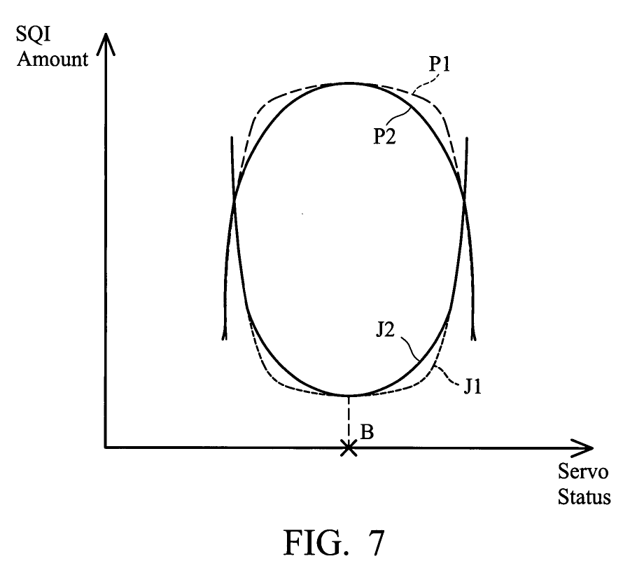

After the system controller 2500 changing the configuration of DRU 2300 from the normal data recovery operation mode to the signal quality index measurement mode, the sensitivity between the signal quality index and the servo status is improved accordingly. FIG. 7 shows an embodiment of the relationship between jitter amount, PRSNR amount and servo status. As shown in FIG. 7, the jitter amount and PRSNT amount for the servo status around the best servo status B becomes more sensitive (line J2 or line P2) than that before the configuration change of DRU 2300 (line J1 or line P1). That is the signal quality index, such as jitter and PRSNR can be used to accurately recognize the best servo status.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An optical disc apparatus, comprising:
an optical pickup irradiating laser light onto a disc, receiving light reflected from the disc, and generating an RF signal in response to the received light; and
a data recovery unit receiving the RF signal from the optical pickup and reproducing data according to the RF signal;
wherein the data recovery unit comprises a first configuration and a second configuration, receives the RF signal from the optical pickup, reproduces data according to the RF signal in the first configuration, and performs a signal quality index measurement of the RF signal in the second configuration

2. The optical disc apparatus of claim 1 wherein the data recovery unit comprises an automatic gain controller performing a gain adjustment on the RF signal to keep the amplitude of the RF signal during data reproduction in the first configuration, and holding or setting a gain of the automatic gain controller to a predetermined value in the second configuration.

3. The optical disc apparatus of claim 1 wherein the data recovery unit comprises:
an automatic gain controller performing a gain adjustment on the RF signal to keep the amplitude of the RF signal during data reproduction in the first configuration, and holding or setting a gain of the automatic gain controller to a predetermined value in the second configuration;
an equalizer receiving the RF signal, boosting the RF signal on a predetermined frequency range, and filtering high frequency band noise;
a digitizing unit digitizing the RF signal from the equalizer;
a detector detecting a signal quality index of the digitized signal from the digitizing unit; and
a noise generator adding a noise to the RF signal input to the equalizer or output therefrom in the second configuration, wherein the noise generator is disabled during data reproduction in the first configuration.

4. The optical disc apparatus of claim 1 wherein the data recovery unit comprises:
an automatic gain controller performing a gain adjustment on the RF signal to keep the amplitude of the RF signal during data reproduction in the first configuration, and holding or setting a gain of the automatic gain controller to a predetermined value in the second configuration;
an equalizer receiving the RF signal, boosting the RF signal on a predetermined frequency range, and filtering high frequency band noise, wherein the equalizer sets a boost quantity thereof to a first non-zero value during data reproduction in the first configuration, and sets the boost quantity thereof to a second non-zero value in the second configuration;
a digitizing unit digitizing the RF signal from the equalizer; and
a detector detecting a signal quality index of the digitized signal from the digitizing unit.

5. The optical disc apparatus of claim 1 wherein the data recovery unit comprises:
an automatic gain controller performing a gain adjustment on the RF signal to keep the amplitude of the RF signal during data reproduction in the first configuration, and holding or setting a gain of the automatic gain controller to a predetermined value in the second configuration;
an equalizer receiving the RF signal, boosting the RF signal on a predetermined frequency range, and filtering high frequency band noise;
a digitizing unit digitizing the RF signal;
a PLL circuit generating a clock signal having a phase synchronization to the digitized RF signal;
a noise generator adding a noise to the PLL circuit in the second configuration, wherein the noise generator is disabled during data reproduction in the first configuration; and
a detector detecting a signal quality index of the digitized signal from the digitizing unit.

6. The optical disc apparatus of claim 5 wherein the PLL circuit comprises a loop filter, and the noise generator adds the noise prior to or after the loop filter.

7. The optical disc apparatus of claim 1 wherein the data recovery unit comprises:
an automatic gain controller performing a gain adjustment on the RF signal to keep the amplitude of the RF signal during data reproduction in the first configuration, and holding or setting a gain of the automatic gain controller to a predetermined value in the second configuration;
an analog to digital converter converting the RF signal from analog to digital;
a first equalizer receiving the RF signal, boosting the RF signal on a predetermined frequency range, and filtering high frequency band noise;
a PLL circuit coupled to the first equalizer, generating a clock signal having a phase synchronization to the RF signal;
a second equalizer receiving the RF signal, boosting the RF signal on a predetermined frequency range, and filtering high frequency band noise, wherein the second equalizer continuously adjusts a coefficient thereof during data reproduction in the first configuration, and holds or sets the coefficient to a predetermined value;
a Viterbi decoder coupled to the second equalizer, Viterbi decoding the equalized RF signal; and
a detector detecting a signal quality index of the RF signal according to the RF signal from the second equalizer and the Viterbi decoding result.

8. The optical disc apparatus of claim 1 wherein the data recovery unit further generates a signal quality index according to the RF signal.

9. The optical disc apparatus of claim 8 wherein the signal quality index comprises a phase based index.

10. The optical disc apparatus of claim 9 wherein the phase based index-comprises a jitter.

11. The optical disc apparatus of claim 8 wherein the signal quality index comprises a level based index.

12. The optical disc apparatus of claim 11 wherein the level based index comprises a PRSNR.

13. The optical disc apparatus of claim 1 wherein a servo status of the optical pickup, including an offset of a focusing servo, an offset of a tracking servo, a spherical aberration, or a radial tilt of the optical pickup is adjusted when the data recovery unit is switched to the second configuration.

14. An optical disc apparatus, comprising:
an optical pickup irradiating laser light onto a disc, receiving light reflected from the disc, and generating an RF signal in response to the received light; and
a data recovery unit receiving the RF signal from the optical pickup, reproducing data according to the RF signal, and generating a signal quality index accordingly;
wherein the data recovery unit comprises a first configuration and a second configuration, receives the RF signal from the optical pickup, reproduces data according to the RF signal in the first configuration, and performs a signal quality index measurement of the RF signal in the second configuration; and a servo status of the optical pickup is adjusted when the data recovery unit is switched to the second configuration.

15. The optical disc apparatus of claim 14 wherein the signal quality index comprises a phase based index.

16. The optical disc apparatus of claim 15 wherein the phase based index comprises a jitter.

17. The optical disc apparatus of claim 14 wherein the signal quality index comprises a level based index.

18. The optical disc apparatus of claim 17 wherein the level based index comprises a PRSNR.

19. The optical disc apparatus of claim 14 wherein the servo status comprises a radial tilt of the optical pickup.

20. An method for use in an optical disc apparatus comprising an optical pickup, and a data recovery unit, wherein the optical pickup irradiates laser light onto a disc, receives light reflected from the disc, and generates an RF signal in response to the received light, and the data recovery unit receives the RF signal from the optical pickup, reproduces data according to the RF signal, and generates a signal quality index accordingly, comprising:
performing an adjustment on the data recovery unit based on the signal quality index, such that the signal quality index becomes sensitive to accurately recognize the best servo status of the optical disc apparatus.
